(19) United States
(12) Patent Application Publication
(10) Pub. No.: US 2011/0226360 A1
(43) Pub. Date: Sep. 22, 2011

(54) Corrugated Criss-Crossing Packing And Column Including Such A Packing

(75) Inventors: Gilles LeBain, Thiais (FR); Francois Leclercq, Lyon (FR)

(73) Assignee: L'Air Liquide Societe Anonyme Pour L'Etude Et L'Exploitation Des Procedes Georges Claude, Paris (FR)

(21) Appl. No.: 13/130,871

(22) PCT Filed: Nov. 16, 2009
(86) PCT No.: PCT/FR2009/052187

§ 371 Date: May 24, 2011

(30) Foreign Application Priority Data
Nov. 24, 2008 (FR) 0857962

(51) Int. Cl. F16L 41/00

(52) U.S. Cl. 137/561 A

(57) ABSTRACT

The present invention relates to a corrugated crisscross packing and to a column incorporating such a packing.

The present invention relates to a corrugated criss-cross packing and to a column incorporating such a packing.

The packings that are ordinarily used consist of corrugated bands comprising parallel alternating corrugations each placed in a general vertical flat surface and one against the other. The corrugations are oblique and descending in opposite directions from one band to the next. The perforation rate is approximately 10% for these packings called corrugated criss-cross packings.

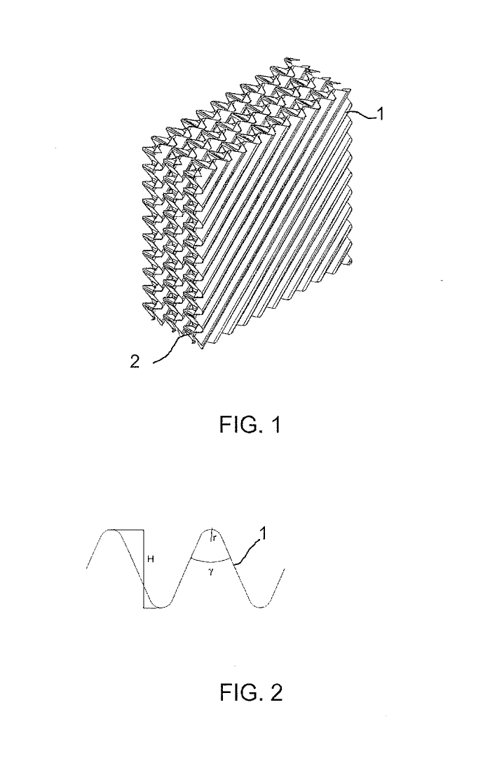

FIG. 1 is an isometric view in perspective of six stacked bands of packings.

GB-A-1004046 discloses packings of the corrugated criss-cross type.

CA-A-1095827 proposes an improvement to this type of packing by adding a dense, small-diameter perforation to allow the liquid to pass from one side to the other of the corrugated criss-cross bands.

This packing is usually manufactured from a flat product, namely metal sheets in the form of bands 1,2 as illustrated in FIG. 1. The bands are first folded (or curved) so as to form a sort of corrugated metal sheet in a band the corrugations of which are oblique relative to the axis of the band. The folded bands are then cut into sections and then stacked while alternately turning over one band out of two.

The sections of packing thus obtained are called “packs”.

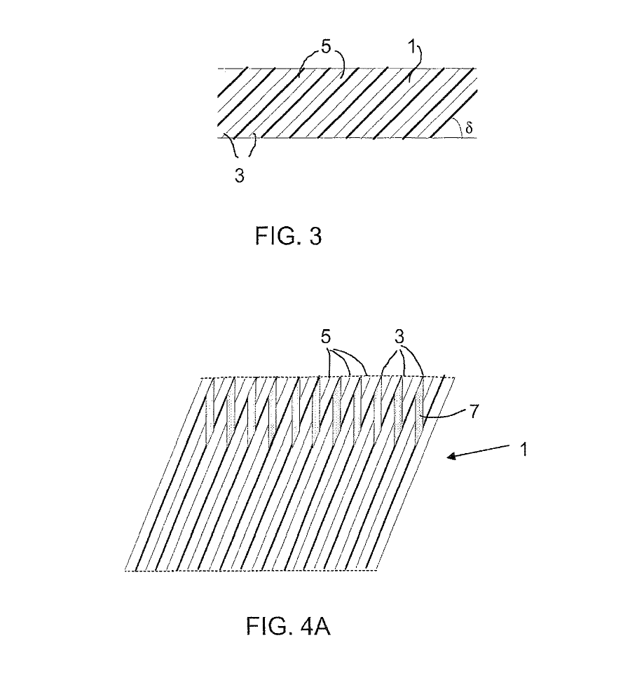

In the case of simple corrugations, as illustrated in FIGS. 2 and 3, the various parameters making it possible to describe a corrugated criss-cross packing are: the height of the waves (H), the folding angle (γ), the radius of curvature (r) and the incline of the waves (δ). Ridge lines 3 and valley lines 5 are thus formed.

### The Addition of Perforations in the Packing Bands

| | Pat. | | | |
|---|---|---|---|---|
| | No. or | | | |
| | sealed | | Priority | |
| Ref. | letter | Applicant | date | Comment |
| 1 | CA | Sulzer | 1976 | Zigzag perforation |
| | 1095827 | | | |
| 2 | U.S. Pat. | Norton | 1987 | Embossing elements split on |
| | No. | | | each side of the band |
| | 4,740,334 | | | |
| 3 | EP | Raschig | 1984 | Narrow flaps (capillarity |
| | 0158917 | | | retained) open in the sides |
| 4 | U.S. Pat. | Glitsch | 1985 | Describes the unfolded |
| | No. | | | metal, slots transversal to |
| | 4,604,247 | | | the flow and all sorts of |
| | | | | apertures, with or without |
| | | | | flap. |
| 5 | EP | Jaeger | 1985 | W-shaped flaps |
| | 0218417 | | | |
| 6 | U.S. Pat. | Glitsch | 1990 | Louvers open laterally in |
| | No. | | | the wave sides |
| | 5,057,250 | | | |
| 7 | EP | BOC | 1995 | Flaps folded to cut the |
| | 0750940 | | | vapor flow and create |
| | | | | turbulence at regular |
| | | | | intervals |
| 8 | U.S. Pat. | Norton | 1985 | Valleys and ridges |
| | No. | | | alternated with zone for |
| | 4,670,196 | | | collecting drops at the base |
| | | | | of each |
| 9 | U.S. Pat. | Mix | 1993 | Adjacent corrugations having |
| | No. | | | ridges offset relative to |
| | 5,407,607 | | | the direction of the |
| | | | | corrugations in a given row. |
| 10 | U.S. Pat. | | 1995 | Pairs of surfaces forming |
| | No. | | | valleys and ridges, |
| | 5,578,254 | | | partially offset and sharing |
| | | | | a portion of ridge |
| 11 | U.S. Pat. | Raschig | 1995 | Corrugated bands arranged |
| | No. | | | side by side with points of |
| | 5,885,694 | | | contact for the passage of |
| | | | | the liquid |
| 12 | EP1417028 | Air | 2000 | Corrugated band comprising |
| | Liquide | | | slots or cutouts in a |
| | | | | direction close to the line |
| | | | | of greatest slope (between |
| | | | | 10 and 20°) |
| 13 | EP1756497 | Air | 2003 | Proposes the arrangement of |
| and | and | Liquide | | a packing with fold |
| 14 | EP1754009 | | | inversion in compliance with |
| | | | | EP1417028 with geometric |
| | | | | features making it possible |
| | | | | to intensify the turbulence |
| | | | | and in compliance with the |
| | | | | requirements of manufacture |
| | | | | or of stacking |

These various patents describe the addition of perforations in the packing band for various reasons, mainly in order to promote the spreading of the liquid, the exchange of liquid between the two faces of the band and the turbulence of the vapor phase.

It is possible to classify these perforations in two broad categories:
The perforations of “small” dimension (such that the forces of capillarity of the liquid are sufficient to maintain a good wetting). Such perforations can be filled by a continuous film of liquid or are small enough for the liquid to run round them without creating a dry zone downstream, for example references: 1, 2, 3, 4, 5, 6.
The perforations of “large” dimension, or the wide-open slots. Such perforations are usually intended to promote turbulence of the vapor phase (cf. FIG. 1), but can have the drawback of hampering the flow of the liquid and of creating dry zones downstream, for example references: 7, 8, 9, 10, 11. On the other hand, references 13 and 14 have the advantage of not disrupting the liquid too much while increasing the turbulence of the gas side but at the expense of severe geometric stresses.

### 1.1 The Addition of a Flat Band Between 2 Corrugated Criss-Cross Bands

| | Pat. | | | |
|---|---|---|---|---|
| | No. or | | | |
| | sealed | | Priority | |
| Ref. | letter | Applicant | date | Comment |
| 1 | EP | BOC | 1999 | Flat band inserted between |
| | 1 063 009 | | | two sheets of corrugated |
| | | | | criss-cross packing (GOC) |
| | | | | either over the whole |
| | | | | height or only in the |
| | | | | vicinity of the edges |
| 2 | EP | BOC | 2000 | Flat bands inserted |
| | 1 166 868 | | | between two bands of GOC |
| | | | | with modified edges, |
| | | | | either in the vicinity of |
| | | | | the edge, or over the |
| | | | | whole height. |
| 3 | U.S. Pat. No. | Glitsch | 1983 | Flat band inserted and |
| | 4,597,916 | | | perforated between bands |
| | | | | of GOC |
| 4 | EP 1 216 | BOC | 2000 | 2 flat bands inserted |
| | 752 | | | between two corrugated |
| | | | | strips and aligned with |
| | | | | the bottom and top edges |
| | | | | of the strips. In the |
| | | | | middle of this band |
| | | | | openings of different |
| | | | | shapes are made. |
| 5 | EP 1 332 | Stichlmair | 2002 | Insertion of a flat band |
| | 794 | | | between two corrugations |
| | | | | having perforations on the |
| | | | | lateral edges and taps for |
| | | | | returning the fluid to the |
| | | | | center |

The addition of these flat bands is above all for the purpose of reducing or even removing the gas/gas disruptions that occur in the packing. Specifically, since the channels of two bands of packing are oriented at 90°, the two gaseous streams are disrupted at the interface: the consequence is a helical movement of the two gaseous streams. These frictions are at the origin of a large proportion of the pressure losses and are not totally of value for the exchange of material. Adding the flat bands eliminates this rolls phenomenon and therefore reduces the dissipations of energy.

There are many drawbacks in adding flat bands:
The overall density of the new packing is increased. It is therefore necessary to increase the height of the corrugated criss-cross to reach an equivalent overall density. This accentuates the profile of concentration within the gaseous stream and therefore reduces the separation performance.
This vortex phenomenon of the gaseous stream allows a renewal of the viscous sublayer at the interface of the liquid. In a second order, it contributes to the exchange of material. Consequently, by removing it totally by adding a flat metal sheet, we remove this slight advantage.
One cannot be sure of completely wetting the flat metal sheet. By virtue of the inclination of the channels, a drop of liquid falling on a packing always ends by encountering aluminum. On the other hand, short of wetting on the edge of the aluminum flat band (0.2 mm thick), there is no guarantee of having a correctly wetted installed surface.

As described above, it is difficult to reconcile the intensification of the turbulence of the vapor phase and a flowing of the liquid either by local deformation or by adding flat metal sheet between two corrugated criss-cross packing elements.

One object of the invention is to show a packing having a corrugated criss-cross base into which flat elements would be incorporated for the purpose of reducing the dissipations of energy. These elements would if necessary be made by cutouts the edges of which are in a direction close to the line with the greatest slope. These flat surfaces would have at least one link and at least one point of contact with the corrugated criss-cross structure thus promoting their wetting.

According to one subject of the invention, a regular packing element is provided intended for material exchange and/or heat exchange columns comprising in alternation a plurality of strips, each strip being corrugated, of generally rectangular shape, the strips being placed one against the other so that the corrugations crossing the strips are oriented at between 50° and 100° to the corrugations of the adjacent strip, thus forming a corrugated-criss-cross structure, at least one bandlet contacting simultaneously at least one first ridge of a strip and at least one second ridge of the strip, the second ridge being adjacent to the first ridge, and characterized in that the or each bandlet is cut out of the strip so as to leave a slot in the corrugation.

According to other optional aspects:
at least one bandlet cut out of the strip so as to leave a slot in the corrugation contacts simultaneously at least one first valley of a strip and at least one second valley of the strip, the second valley being adjacent to the first valley;
the bandlets are cut out of the strip, leaving a slot in the corrugation of the same shape as the bandlet;
the bandlets are of triangular or parallelepipedal shape;
a bandlet is formed by two triangular or parallelepipedal elements, one bandlet joining a ridge of one strip and another bandlet joining the adjacent ridge, the two elements joining together between two ridges;
the bandlets extend at an angle of between 10° and 60° to the ridges (to the valleys) of the strip;
the bandlet is of elongate shape, preferably flat, one side of the bandlet being attached to a ridge (a valley);
the bandlet extends just beyond the adjacent ridge;
an opposite side of the bandlet being contiguous with the adjacent ridge (the valley);
the length of the bandlet is greater than the length of wave of the strip, preferably at least two times greater than the length of wave of the strip.

According to another aspect of the invention, a column for exchange of material and/or of heat is provided fitted with an element as described above, the strips being oriented vertically, for example a cryogenic distillation column, in particular for air.

The inserted flat portions link ridges or valleys of waves together. This locally prevents the turbulence of the packing wave stacked at 90°.

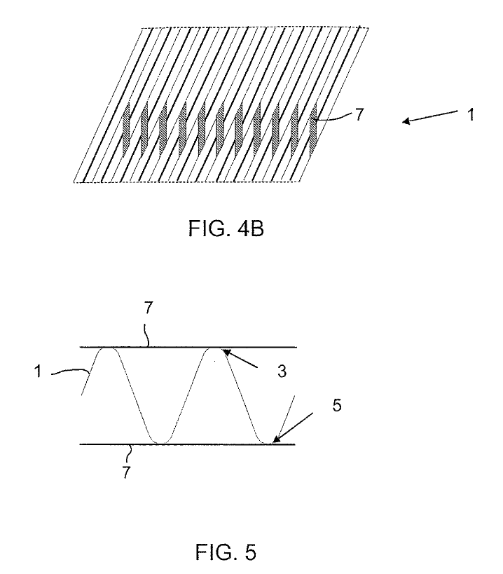

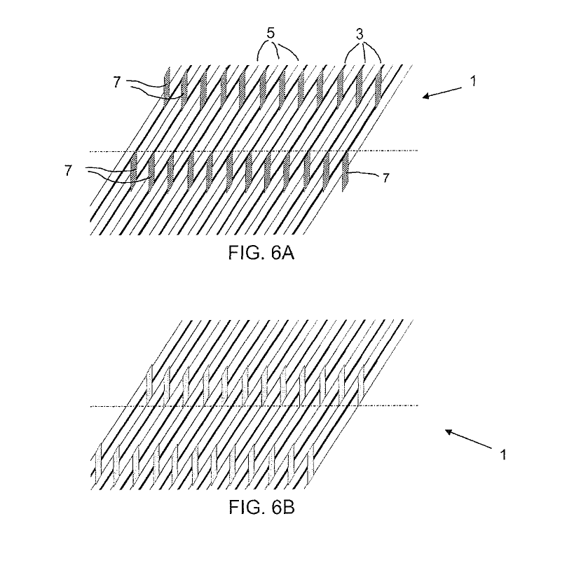

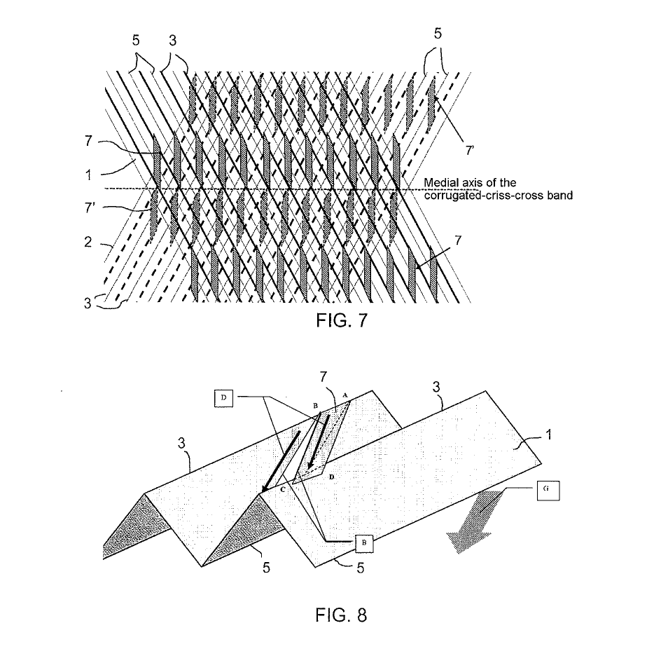

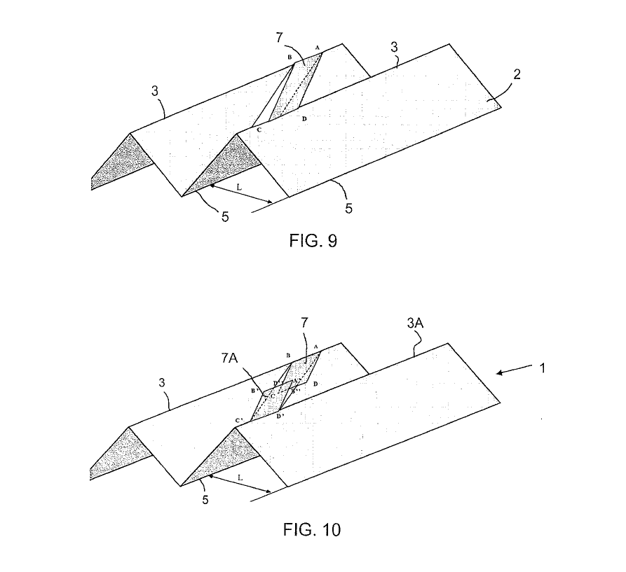

The invention will be described in greater detail with reference to the figures. FIGS. 4A and 4B show schematically a strip of a packing according to the invention seen from above and from below, FIG. 5 shows a packing strip according to the invention seen from the side, FIGS. 6A and 6B show schematically a strip of packing according to the invention seen from above and from below, FIG. 7 shows two superposed strips of a packing according to the invention seen from above, with an idea of the lower strip, FIGS. 8, 9 and 10 show isometric perspectives of a strip of a packing according to the invention.

FIG. 4A shows a view from above of a strip 1 with a series of bandlets 7, each connecting only two successive ridges 3 at the same height of the strip.

FIG. 4B shows a view from below of a strip 1 with a series of bandlets 9, each connecting only two successive valleys 9 at the same height of the strip.

It will be understood that FIGS. 4A and 4B could be combined so that the strip comprises one series of bandlets linking the ridges and another series of bandlets linking the valleys, the two series being spaced apart from one another.

The drawing of FIG. 5 shows a view in the axis of the folds. The “conventional” profile of the corrugated criss-cross can be seen for the strip 1. The bandlet(s) 7, actually consisting of a series of flat surfaces, link(s) the ridges 3 of the strip. The bandlet(s) 9, in fact consisting of a series of flat surfaces, link(s) the valleys 5 of the strip 1.

FIGS. 6A and 6B show a version of FIGS. 4A and 4B comprising a second series of bandlets, these FIGS. 6A and 6B evidently being able to be combined.

FIG. 7 shows two strips each having only two series of bandlets 7 linking the ridges. The distance between two series of ridges is chosen so that the slots of one strip 1 are not superposed over those of the successive strip 2.

FIG. 8 is a view in perspective of a packing strip according to the invention. The strip 1 usually comprises at least one cutout forming a bandlet 7 in the form of a parallelepiped ABCD having at least one of the following characteristics:
at least one of the edges AD or BC has a direction less than 20°, or even less than 10°, from the line of greatest slope, this line being defined (definition to be added),
one side AB (or CD) is a fold situated on a ridge 3 (or a valley 5) of the strip 1 forming part of the corrugated criss-cross packing. This side has the same inclination relative to the horizontal as the angle of inclination δ of the channels (usually between 45 and 60°),
the last side CD is an edge obtained by a cutting out and is positioned so that the flat surface ABCD comes into contact with another element of the strip 1 (for example only the successive ridge 3).

To prevent any phenomenon of accumulation and of appearance of droplets on the end CD that can generate a separation of the liquid, it can be envisaged that the edge CD is indistinguishable (aligned and in contact) from a successive ridge 3, as illustrated in FIG. 8 for a strip 2. For this, the distance of the straight lines passing through AB and CD must be equal to the pitch of the wave L. This arrangement clearly also applies for the bandlets 9 contacting the valleys 5.

Alternatively, as illustrated in FIG. 10, a flat surface 7 linked with a ridge 3 of a strip 1 can contact the flat surface 7A linked with the successive ridge 3A of the same strip. Therefore the flat surface incorporated into the corrugated criss-cross packing is made from two parallelepipeds:
ABCD (flat surface 7) that would be linked to the strip 1 by the side AB indistinguishable from the ridge 3
A′B′C′D′ (flat surface 7A) that would be linked to the strip 1 by the side C′D′ indistinguishable from the ridge 3A.

The bandlet therefore consists of two flat surfaces 7,7A.

The requirement for promoting the passage of the liquid from one facet to the other is to have a superposition and contact of one portion of their surface with each other (in this instance shown by the parallelogram A′B″CD″).

For this configuration of FIG. 10, it is possible to produce these two flat surfaces no longer linked at the wave ridges or at the wave valleys but at any elevation of the sides in order to achieve a cutting of the gaseous stream.

The packing modules according to the invention can of course include other devices.

Varied surface treatments, for example:

| | | | |
|---|---|---|---|
| U.S. Pat. No. | Sulzer | 1977 | Micro-corrugations transverse to |
| 4,296,050 | | | the flow of the liquid in order |
| | | | to spread it. |
| EP 0190435 | Sulzer | 1985 | Unlanced zigzag embossing |

Devices for preventing flooding at the interface between packing bodies, such as those described in the following patents:

| | | | |
|---|---|---|---|
| U.S. Pat. No. | Munters | 1990 | Vertical offset in the modules |
| 5,013,492 | | | of one packing band out of two |
| | | | in order to reduce the density |
| | | | in the vicinity of the |
| | | | interfaces. |
| FR 2686271 | AL | 1992 | Insertion of spacers between the |
| | | | modules |
| JP 6312101 | Hitachi | 1993 | Insertion of modules of lesser |
| | | | density between the distillation |
| | | | modules |
| U.S. Pat. No. | Praxair | 1996 | Reduction in the height of |
| 5,632,934 | | | corrugation, change of |
| | | | inclination of the channels, |
| | | | production of openings in the |
| | | | vicinity of the base of the |
| | | | modules. |
| WO 97/16247 | Sulzer | 1995 | Progressive change in the |
| | | | inclination of the channels up |
| | | | to the vertical at the edges of |
| | | | the bands, installation of |
| | | | grating between the modules. |

Experimental tests have proved that the flooding of a packing occurs first at the interface between the modules, in a location where the gas is forced to change direction at an angle of approximately 90° in order to pass from one module to the other. Therefore, the capacity of the column is limited while the central portion of the modules has not yet reached its flooding point.

This phenomenon is analyzed in terms of flooding of liquid in the bottom portion of the modules in the vicinity of the interface: the pressure loss sustained by the gas at the change of direction causes an accumulation of liquid in the adjacent zone. The accumulation of liquid causes premature flooding of the column.

The invention allows the cost-effective manufacture of corrugated criss-cross packing having better performance. It is therefore possible to reduce the volume of packing used for treating a given flow rate without loss of efficiency since the same quantity of metal used for a conventional corrugated-criss-cross packing (without slots) is used to create a more efficient packing. Used in the context of the cryogenic distillation of air, it therefore makes it possible to reduce the size of the columns and of the cold boxes.

The invention allows a reduction in investment in the distillation column.

1-10. (canceled)

11. A regular packing element designed for material exchange and/or heat exchange columns comprising;
in alternation a plurality of strips, each strip being corrugated, of generally rectangular shape,
the strips being placed one against the other so that the corrugations crossing the strips are oriented at between 50° and 100° to the corrugations of the adjacent strip, thus forming a corrugated-crisscross structure,
at least one bandlet contacting simultaneously at least one first ridge of a strip and at least one second ridge of the strip, the second ridge being adjacent to the first ridge,
wherein the or each bandlet is cut out of the strip so as to leave a slot in the corrugation.

12. The element of claim 11, wherein at least one bandlet, cut out of the strip so as to leave a slot in the corrugation contacts simultaneously at least one first valley of a strip and at least one second valley of the strip, the second valley being adjacent to the first valley.

13. The element of claim 11, wherein the bandlets are cut out of the strip, leaving a slot in the corrugation of the same shape as the bandlet.

14. The element of claim 11, wherein the bandlets are of triangular or parallelepipedal shape.

15. The element of claim 11, wherein a bandlet is formed by two triangular or parallelepipedal elements, one bandlet joining a ridge of one strip and another bandlet the adjacent ridge, the two elements joining together between two ridges.

16. The element of claim 15, wherein the bandlets formed by two triangular or parallelepipedal elements are substantially identical.

17. The element of claim 11, wherein the bandlets extend at an angle of between 10° and 60° to the ridges or to the valleys of the strip.

18. The element of claim 11, wherein the bandlet is of elongate shape, one side of the bandlet being attached to a ridge or a valley.

19. The element of claim 18, wherein the bandlet of elongate shape is flat.

20. The element of claim 11, wherein the bandlet extends just beyond the adjacent ridge.

21. The element of claim 11, further comprising an opposite side of the bandlet, being contiguous with the adjacent ridge or valley.

22. The element of claim 11, wherein the length of the bandlet is greater than the length of wave of the strip.

23. The element of claim 22, wherein the length of the bandlet is at least two times greater than the length of wave of the strip.
